(19) United States
(12) Patent Application Publication
(10) Pub. No.: US 2017/0129536 A1
(43) Pub. Date: May 11, 2017

(54) HILL PARKING AID

(71) Applicant: FORD GLOBAL TECHNOLOGIES, LLC, Dearborn, MI (US)

(72) Inventors: Li XU, Northville, MI (US); Eric Hongtei TSENG, Canton, MI (US)

(21) Appl. No.: 14/937,961

(22) Filed: Nov. 11, 2015

(51) Int. Cl. B62D 15/02; B62D 6/00

(52) U.S. Cl. CPC B62D 15/027; B62D 6/001; B62D 15/025

(57) ABSTRACT

A vehicle includes a parking assist system that identifies an inclination of the vehicle and an angle of wheels relative to a centerline of the vehicle. The vehicle also includes a controller that, in response activation of the vehicle, the inclination exceeding a first threshold, and the angle exceeding a second threshold, adjusts the angle to center the wheels relative to the centerline.

### TECHNICAL FIELD

The present disclosure relates to parking assist systems for vehicles.

### BACKGROUND

When a vehicle is parked on a hill, a driver may angle the wheels in a certain direction to prevent the vehicle from rolling. For example, the front wheels of the vehicle may be angled away from the curb if the vehicle is facing uphill, toward the curb if the vehicle is facing downhill, or to the right if no curb is present.

### SUMMARY

A parking assist system for a vehicle includes a controller configured to, in response to activation of the vehicle and data indicating that an inclination of the vehicle exceeds a first threshold and a steering angle of the vehicle exceeds a second threshold, adjust the steering angle to center wheels of the vehicle.

A vehicle includes a parking assist system configured to identify an inclination of the vehicle and an angle of wheels relative to a centerline of the vehicle, and a controller configured to, in response activation of the vehicle, the inclination exceeding a first threshold, and the angle exceeding a second threshold, adjust the angle to center the wheels relative to the centerline.

A control method for a parking assist system of a vehicle includes, in response to activation of the vehicle and data indicating a vehicle incline exceeding a first threshold and a steering angle exceeding a second threshold, adjusting by a controller the steering angle to center a set of wheels of the vehicle.

### BRIEF DESCRIPTION OF THE DRAWINGS

FIG. 1 is a schematic view of a vehicle parked on an inclined roadway; and

FIG. 2 is a control logic flow diagram for centering the wheels of the vehicle after vehicle activation.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

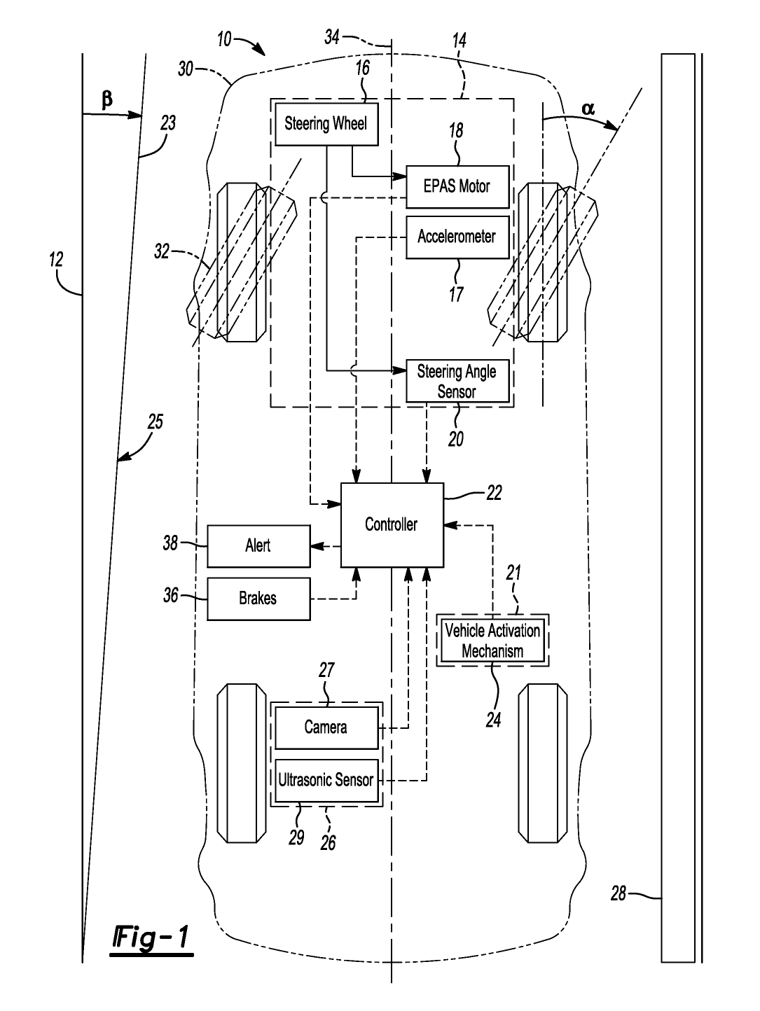

FIG. 1 depicts a schematic view of a vehicle 10 parked on an inclined roadway 12. The vehicle 10 includes a steering system 14 having a steering wheel 16, an accelerometer 17, an EPAS motor 18, and a steering angle sensor 20 in communication with a controller 22. The steering angle sensor 20 may include a pinion angle sensor, a steering wheel angle sensor, or any other sensor that may be configured to determine an angle of vehicle wheels 32. Further, the vehicle 10 includes a parking assist system 21 to communicate, using near field communication, between the controller 22 and an activation transceiver 24. While preferred, any other communication system may allow communication between the controller 22 and the activation transceiver 24, such as but not limited to, Bluetooth, WiFi, dedicated short range communication, or in-vehicle networks. The activation transceiver 24 may start, or ignite a vehicle engine to allow the vehicle 10 to propel forward or deactivate the vehicle and turn off a vehicle engine in order to park the vehicle 10. The controller 22 may also be in communication with a vehicle vision system 26 including a camera 27 or an ultrasonic sensor 29, as well as a navigation system 25 and a map 23 to detect the presence of a curb 28. Any other vehicle vision sensors may be used to communicate the presence of the curb 28 to the controller 22.

The inclined roadway 12 has an incline β. Incline β corresponds with a steering angle α. The steering angle α may be defined as an angle between the wheels 32 and a center 34 of the vehicle 10. As incline β reaches a first threshold, the accelerometer 17 communicates that the incline β is above the first threshold to the controller 22. The controller 22 uses the steering system 14 to account for the incline β of the roadway 12. As by way of example, the steering system 14 uses the incline data from the controller 22 to activate the EPAS motor 18 to adjust the steering wheel 16 such that the steering angle α exceeds a second threshold. The steering system 14 may also be configured to adjust the steering angle α by angling the wheels 32 in vehicles without a steering wheel. The controller 22 may also use the accelerometer 17 to determine which direction the steering system 14 should adjust the wheels 32. For example, FIG. 1 depicts a scenario in which a front 30 of the vehicle 10 faces downhill and the incline β exceeds the first threshold. When a front 30 of the vehicle 10 faces downhill, the controller 22 instructs the steering system 14 to adjust the vehicle wheels 32 toward the curb 28 to achieve the steering angle α. Angling the wheels 32 toward the curb 28 when the front 30 of the vehicle 10 faces downhill allows the curb 28 to act as a stop, preventing the vehicle 10 from rolling downhill. Downhill may be defined when the front 30 of the vehicle 10 faces toward a decline 23 of a slope 25 of the inclined roadway 12.

While depicted in FIG. 1, the controller 22 may use the accelerometer 17 to account for similar scenarios. For example, if the controller 22, using the accelerometer 17, determines a front 30 of the vehicle faces uphill while the incline β of the roadway 12 still exceeds the first threshold, the controller 22 instructs the steering system 14 to adjust the vehicle wheels 32 away from the curb 28 to achieve the steering angle α. Angling the wheels 32 away from the curb 28 when the front 30 of the vehicle 10 faces uphill allows the curb 28 to prevent the vehicle 10 from rolling down the roadway 12. Uphill may be defined when the front 30 of the vehicle faces toward an incline (not shown) of the slope 25 of the inclined roadway 12.

The controller 22 may angle the wheels 32, using the steering system 14 as described above, when the activation transceiver 24 indicates the vehicle 10 is off and the steering angle sensor 20 indicates the wheels 32 are aligned with a center 34 of the vehicle 10. This allows the steering system 14 to automatically adjust the wheels 32 to further park the vehicle 10 on the inclined roadway 12.

The controller 22 is also configured to use the steering system 14 to align the wheels 32 with the center 34 of the vehicle 10 when the activation transceiver 24 indicates vehicle activation. For example, when the parking assist system 21 indicates to the controller 22 that the distance between the activation transceiver 24 and the parking assist system falls below a third threshold, the controller will instruct the steering system 14 to align the wheels 32 with the center 34 of the vehicle. The third threshold may preferably be when the activation transceiver 24 is within a cabin (not shown) of the vehicle 10. However, the parking assist system 21 may also indicate that the activation transceiver 24 is within the third threshold at a predetermined distance from the parking assist system 21. The predetermined distance may be based on the range of near field communication systems.

For example upon actuation of the activation transceiver 24, the controller 22 receives input from the steering angle sensor 20 indicating that the wheels 32 have been angled at the steering angle α exceeding the second threshold and from the accelerometer 17 that the vehicle 10 is on the incline β exceeding the first threshold. The controller instructs the steering system 14 to actuate the EPAS motor 18 to turn the wheels 32, based on the input from the steering angle sensor 20, to align the wheels 32 with the center 34 of the vehicle 10. Aligning the wheels 32 with the center 34 of the vehicle 10 prepares the vehicle 10 for road use. Further, the controller 22 may also instruct the steering system 14 to further adjust the steering angle α such that the wheels 32 are angled away from the curb 28 and toward the roadway 12 to prepare the vehicle 10 for road use. The parking assist system 21 may also be configured to send an input signal to the controller 22 indicating cancellation of the steering system 14 centering maneuver described above.

For example, if the incline β exceeds the first threshold and the steering angle α exceeds the second threshold and the activation transceiver 24 is within the third threshold of the parking assist system 21 and indicates vehicle activation, but an operator (not shown) indicates that aligning the wheels 32 with the center 34 of the vehicle 10 may not be ideal, the operator may apply a brake 36 for the vehicle 10. Applying the brake 36 alerts the controller 22 that centering the wheels 32 may not be necessary and the controller 22 may likewise instruct the steering system 14 to maintain the wheels 32 at the steering angle α. Likewise, the operator may grab the steering wheel 16 to alert the controller 22 that centering the wheels may not be necessary.

Further, the steering system 14 may adjust the steering angle α to center the steering wheel 16 between vehicle activation and displacement of the brake 36. This allows the parking assist system 21 to account for varying circumstances that may arise during operation of the vehicle 10. Further, the controller 22 may also be configured to apply the brake 36 while the steering system 14 is aligning the wheels 32 with the center 34 of the vehicle. If the accelerometer 17 indicates that the incline β of the roadway 12 requires the brakes 36 be applied while the wheels 32 are centered, the controller 22 may likewise be configured to automatically apply the brakes 36 while the steering system 14 centers the wheels 32.

The controller 22 may also be configured to activate an alert 38 of the pending centering of the wheels 32 by the steering system 14. In at least one embodiment, the alert 38 may be an audible tone or dialect indicating that the steering system 14 is aligning the wheels 32 with the center 34 of the vehicle 10. The alert 38 may also include a visual indication of the maneuver, or by providing haptic feedback indicating the maneuver. The alert 38 allows the operator the opportunity to abort aligning the wheels 32 with the center 34 of the vehicle 10 as described above. The alert 38 ensures that the operator is aware of the maneuver by the steering system 14 and may be able to control the vehicle 10 if needed.

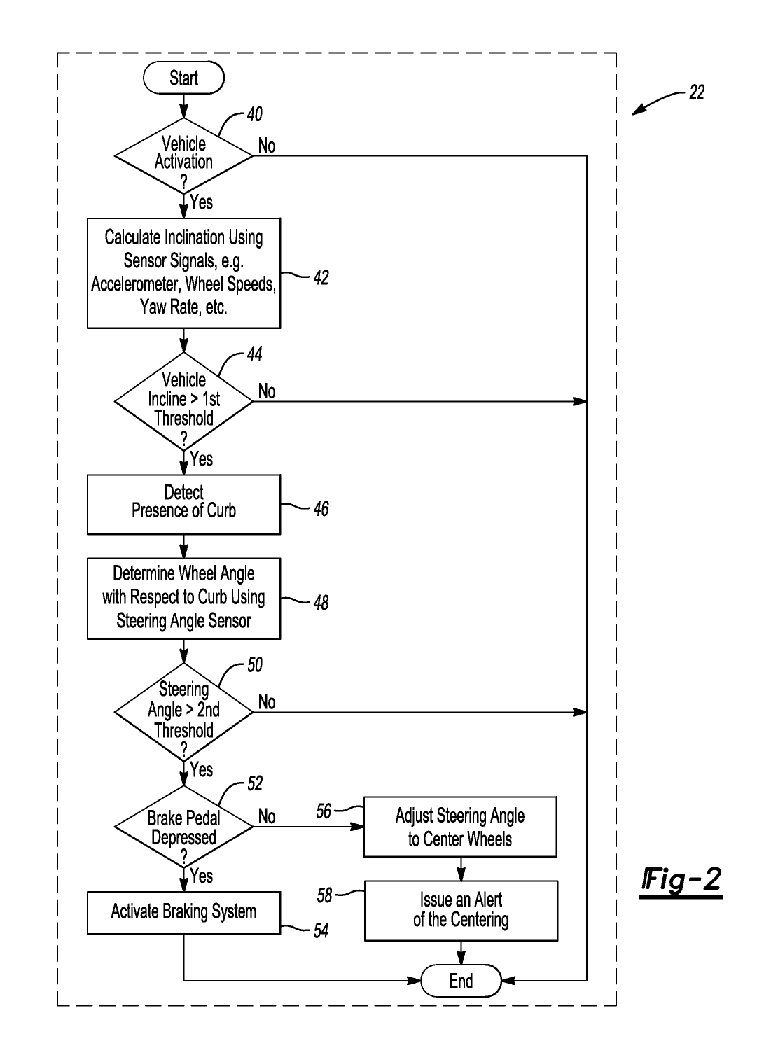

FIG. 2 depicts control logic for the controller 22 to center the wheels 32 of the vehicle 10. At 40, the controller 22 determines if the activation transceiver is within range of the vehicle 10 or is sending data indicating vehicle activation. If at 40 the controller 22 does not receive data indicating vehicle activation from the activation transceiver, the control logic ends. If however at 40 the controller 22 does receive data indicating vehicle activation, the controller 22 uses the accelerometer to calculate the inclination of the roadway at 42. The controller 22 uses the inclination data at 42 to determine if the vehicle inclination is greater than a first threshold at 44. If the vehicle inclination is not greater than a first threshold at 44, the control logic ends. If the controller 22 determines that the vehicle inclination is greater than the first threshold at 44, the controller 22 may use the vision system, such as an ultrasonic sensor or camera to detect the presence of a curb 46.

The controller 22 then receives input, using the steering angle sensor 20, of the wheel angle at 48. The controller 22 uses the input of the steering angle at 48 as well as the presence of the curb at 46 to determine if the steering angle is greater than the second threshold at 50. If the curb is present at 46 and the steering angle has been adjusted at 48 to account for the curb, the controller 22 may then determine at 50 if the wheels 32 have been sufficiently angled toward the curb, exceeding the second threshold. If at 50 the controller determines that the steering angle does not exceed the second threshold and the wheels 32 do not need to be centered, the control logic ends. If however the controller 22 determines at 50 that the steering angle exceeds second threshold, the controller 22 determines at 52 whether centering the wheels 32 using the steering system 14 should be canceled. For example, at 52 the controller 22 will determine if a brake pedal has been depressed, as described above.

If at 52 the controller 22 determines that a brake pedal has been depressed, the controller 22 will activate the braking system at 54. After activating the braking system at 54 the control logic ends. If, at 52, the controller determines that a brake pedal has not been depressed, the controller 22 will adjust the steering angle, using the steering system 14, to align the wheels 32 with the center of the vehicle 10 at 56. While the controller 22 centers the wheels 32 with respect to the vehicle 10, the controller 22 also will issue an alert of the centering at 58. As stated above, issuing the alert of the centering at 58 further provides control and communication such that an occupant is aware of the adjustment at 56. After the wheels 32 have been centered at 56 and the alert has been issued at 58 the control logic ends and the vehicle 10 is ready for travel.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

1. A parking assist system for a vehicle comprising:
a controller configured to,
in response to activation, via actuation of an ignition switch, of the vehicle and data indicating that an inclination of the vehicle exceeds a first threshold and a steering angle of the vehicle exceeds a second threshold, adjust the steering angle to center wheels of the vehicle, and output an alert corresponding thereto.

2. The parking assist system of claim 1, wherein the controller is further configured to, in response to brake pedal feedback, abort the adjusting.

3. (canceled)

4. The parking assist system of claim 1, wherein the controller is further configured to, in response to deactivation of the vehicle and data indicating that the vehicle is facing downhill on a sloped roadway with a curb, adjust the steering angle to point the wheels toward the curb.

5. The parking assist system of claim 1, wherein the controller is further configured to, in response to deactivation of the vehicle and data indicating that the vehicle is facing uphill on a sloped roadway with a curb, adjust the steering angle to point the wheels away from the curb.

6. A vehicle comprising:
a parking assist system configured to identify an inclination of the vehicle and an angle of wheels relative to a centerline of the vehicle; and
a controller configured to, in response activation of the vehicle based on an actuation of an ignition switch, the inclination exceeding a first threshold, and the angle exceeding a second threshold, adjust the angle to center the wheels relative to the centerline and output an alert corresponding thereto.

7. (canceled)

8. (canceled)

9. The vehicle of claim 6, wherein the controller is further configured to, in response the activation, the inclination exceeding the first threshold, and the angle exceeding the second threshold, activate an alert.

10. The vehicle of claim 6, wherein the activation is defined by occurrence of a distance between an activation transceiver and the parking assist system falling below a third threshold.

11. The vehicle of claim 6, wherein the controller is further configured to, in response to brake pedal feedback, abort the adjusting.

12. A control method for a parking assist system of a vehicle comprising:
in response to activation of the vehicle via actuation of an ignition switch and data indicating a vehicle incline exceeding a first threshold and a steering angle exceeding a second threshold, adjusting by a controller the steering angle to center a set of wheels of the vehicle and outputting an alert corresponding thereto.

13. The control method of claim 12, wherein the activation is defined by occurrence of a distance between an activation transceiver and the parking assist system falling below a third threshold.

14. (canceled)

15. The control method of claim 12 further comprising aborting the adjusting in response to brake pedal feedback.

16. (canceled)

17. The control method of claim 12 further comprising applying a brake during the adjusting.
